(19) United States
(12) Patent Application Publication
(10) Pub. No.: US 2025/0258012 A1
(43) Pub. Date: Aug. 14, 2025

(54) METHOD FOR ASSEMBLING A LOCAL HIGH-DEFINITION MAP, SYSTEM FOR USING MAP DATA, COMPUTER PROGRAM PRODUCT AND COMPUTER READABLE MEDIUM FOR IMPLEMENTING THE METHOD

(71) Applicant: Commsignia Kft., Attala (HU)

(72) Inventors: Gergely György Regula, Budapest (HU); Nándor Szalma, Röszke (HU); Alex Badics, Tata (HU)

(21) Appl. No.: 18/855,128

(22) PCT Filed: Apr. 11, 2023
(86) PCT No.: PCT/HU2023/050017

§ 371 Date: Oct. 8, 2024

(30) Foreign Application Priority Data
Apr. 8, 2022 (HU) P2200111

(51) Int. Cl. G01C 21/00; G01C 21/30; G08G 1/16

(52) U.S. Cl. CPC G01C 21/3841; G01C 21/30; G01C 21/3819; G01C 21/3822; G08G 1/16

(57) ABSTRACT

A method for assembling a local high-definition map comprises receiving path histories. Each path history comprises a set of location points that an entity consecutively traversed. The method further comprises constructing, based on the path histories, an initial undirected graph comprising location nodes, intersection nodes and edges. Each location node corresponds to one of the location points. Each intersection node corresponds to an intersection point of two of the path histories. Edges are defined between location nodes corresponding to adjacent location points of one of the path histories, and, in case of an intersection node, edges are defined between the intersection node and location nodes corresponding to location points of each of the respective two path histories between which location points the respective intersection point lies. The method further comprises generating, in a reduction step, a reduced graph by removing redundancies of the received path histories.

### TECHNICAL FIELD

The invention relates to a method for assembling a local high-definition map and a system for using map data. The invention relates also to a computer program product and computer readable medium implementing the method.

The invention relates to Cooperative Intelligent Transportation Systems (C-ITS) that allows for communication between vehicles, infrastructure and other roadside units. This way of communication is also known as V2X (Vehicle-to-Everything). Radio and protocol implementations are not crucial for the V2X systems, thus the V2X systems can be implemented or integrated into any current or future systems.

Through V2X communication vehicles and other traffic participants can share information about the surrounding road topology and geometry, which fundamentally enhances their location and situation awareness. Furthermore, such shared information immediately improves the quality of decisions and the efficiency of filtering, i.e., selecting the relevant situations to be dealt with, such as a potentially dangerous situation.

Map-matching is a procedure to assign objects—for example, vehicles or other traffic participants—to locations on a digital map. Data obtained from a positioning system can naturally have uncertainties, thus matching the position of an object within the digital map results in a more accurate positioning and contributes to better situation awareness. This more accurate position information of objects with any geographical relevance can support movement prediction of a vehicle or any traffic participants, thus contributing to a more established decision-making.

Map-matching algorithms usually use inputs generated from positioning technologies (such as a Global Navigation Satellite System (GNSS), for the example Global Positioning System (GPS), a GNSS integrated with Dead Reckoning (DR) or with Real-Time Kinematics (RTKS)) and supplement these inputs with data from an accurate road network map to find an object's travel route. The general purpose of a map-matching algorithm is to identify the correct map object (e.g., a road segment) on which the vehicle or any other entity with geographical relevance is travelling (or standing) preferably based on past position data, and to determine a corrected or matched location of the vehicle or the other entity on that road segment. Therefore, map-matching is a prerequisite of various location-based applications, such as navigation or vehicle tracking.

The precision of map-matching highly depends on the quality of the map used for map-matching. The more detail a map contains, the more accurate the map-matching result can be. Map data (normally in a form of digital map data) is typically provided by map providers (e.g., Google Maps, HERE, etc.), but can come from any source (e.g., a file of any format uploaded to a processing entity). In order to reduce computing capacity and memory size for storing a map, many map providers provide their map in a standard definition map (SD map) format. Certain V2X applications, however, can benefit more from having a high-definition (HD) map that preferably contains lane-level information. Providing an HD map is rather difficult in most areas of the world, even in highly developed regions like Europe or North America, due to technological and financial reasons. For example, mapping an entire area (typically, a whole city or country) is a cumbersome and costly process, therefore HD maps are considerably more expensive than SD maps.

### BACKGROUND ART

Map-matching and V2X applications are well known to the industry. Overviews on commonly used map-matching methods can be found in Chao P. et al.: “A Survey on Map-Matching Algorithms.” In: Borovica-Gajic, R., Qi, J., Wang, W. (eds) Databases Theory and Applications, ADC 2020, Lecture Notes in Computer Science, vol 12008. Springer, Cham (2020), and in Mohammed A. Quddus et al.: “Current map-matching algorithms for transport applications: State-of-the art and future research directions,” in: Transportation Research Part C: Emerging Technologies, 2007, vol. 15, no. 5, pp. 312-328 (2007).

Furthermore, U.S. Pat. No. 11,127,292 B2 discloses methods and apparatus for determining lane-level static and dynamic information. The document determines lane-level data based on a cloud of latitude and longitude traces of a vehicle.

US 2015/0025789 A1 discloses a technique for lane assignment in a vehicle, wherein a lane assignment is performed based on past trajectories. The technique disclosed in this document only determines a relative lane assignment compared to a vehicle (ego-vehicle).

In view of the known approaches, there is a need for a method which allows for assembling a local high-definition map that preferably can be used for map-matching or other applications benefiting from knowledge of a detailed, high-precision map, especially in cases when no other high-definition map is available.

### DESCRIPTION OF THE INVENTION

The primary object of the invention is to provide a method for assembling a local high-definition map, which is free of the disadvantages of prior art approaches to the greatest possible extent.

A further object of the invention is to provide a system for increasing the precision of localizing other entities in a traffic ecosystem and therefore support decision making.

Furthermore, the object of the invention is to provide a non-transitory computer program product for implementing the steps of the method according to the invention on one or more computers and a non-transitory computer readable medium comprising instructions for carrying out the steps of the method on one or more computers.

The objects of the invention can be achieved by the method according to claim 1. The objects of the invention can be further achieved by the system according to claim 8, the non-transitory computer program product according to claim 15, and by the non-transitory computer readable medium according to claim 16. Preferred embodiments of the invention are defined in the dependent claims.

As it has been discussed above, in many regions of the world no high-definition map is available, however, having a high-definition map can greatly increase map-matching precision and thereby support decision making. A lack of HD maps is a major obstacle to the creation of applications requiring HD maps in developed countries, such as applications that evaluate traffic data at a lane-level, e.g., the applications that are also mentioned in the present specification. While the industry would already be open to advanced driver assistance systems taking lane-level information into account when making decisions for traffic safety, mapping a road network at a HD level using conventional map-generation techniques would still take many years.

A further advantage of the present invention is that it is able to check the accuracy of the HD maps when they will be available, and the present invention can also help to track changes in the HD maps. The invention also provides a solution for cases where the HD map service is not available for some reason, for example in case of failure of the telecommunication network (e.g., 5G) transmitting it or coverage problems.

It is a very important advantage of the method according to the invention is that it is capable of producing a local high-definition map, i.e., a map that can contain lane-level information of a geographical area.

A further advantage of the method according to the invention that it can use real-time or very recent traffic data, therefore the generated local high-precision map may contain information about any recent changes of the map, i.e., a sudden unavailability of a lane due to an accident, an ongoing roadwork, or a recently finished roadwork allowing more lanes or roads to connect to a geographical area in question.

It has been recognized that creating one's own local high-precision map can contribute to better situation awareness, better decision making and higher availability, where otherwise no HD map is available.

### BRIEF DESCRIPTION OF THE DRAWINGS

Preferred embodiments of the invention are described below by way of example with reference to the following drawings, where

FIGS. 1A-1C show an exemplary implementation of the method according to the invention of assembling a local high-definition map,

FIGS. 2A and 2B are exemplary use case scenarios of the method according to the invention,

FIG. 3 is a block diagram of a preferred embodiment of the system according to the invention,

FIG. 4 is a graph showing an exemplary angle difference shaping function, and

FIG. 5 is a graph showing an exemplary distance difference shaping function.

### MODES FOR CARRYING OUT THE INVENTION

The invention relates to a method for assembling a local high-definition (HD) map, which can preferably be used for any applications requiring a local high-definition map, or benefiting from using one.

The method according to the invention comprises a step of receiving a plurality of path histories, wherein each path history comprises a set of location points that an entity consecutively traversed. The path histories are preferably received via V2X messages, even more preferably are received from nearby entities that are able to share their position information. Preferably, the path histories are received for a predetermined geographical area around a current position of an ego-vehicle, and/or the path histories are received for a time period (e.g., 30 minutes, an hour, 2 hours) prior to the arrival of the ego-vehicle into said geographical area.

In a preferred implementation of the method according to the invention, the path histories of nearby entities are collected by a processing unit of a receiving entity, wherein a receiving entity can for example be an ego-vehicle, or a road side unit that transmits the collected path histories to other entities in demand for path histories.

The method according to the invention further comprises a step of constructing, based on the plurality of path histories, an initial undirected graph comprising location nodes, intersection nodes and edges. In the initial undirected graph, each location node corresponds to one of the location points (i.e., a location point of any of the received path histories), each intersection node corresponds to an intersection point of two of the path histories, and edges are defined between location nodes corresponding to adjacent location points of one of the path histories, and for intersection nodes edges are defined between the intersection node and two location nodes of each of the respective two path histories between which the intersection point lies.

Preferably, path histories are received as an ordered set (or matrix) of positions, e.g., a path history location point P_{i,j} denotes a j-th location point of an i-th path history. Location nodes are defined in the initial undirected graph for each one of the path history points P_{i,j}.

If two path histories are having an intersection point Xₖ, an intersection node is defined for said intersection point Xₖ. An intersection point can be defined the following way: if a path generated based on a first path history intersects with a path generated based on a second path history, a point, where said two paths intersect each other is the intersection point Xₖ. A path can be generated by connecting the adjacent location points P_{i,j} and P_{i,j+1} of a given path history or by interpolating between the adjacent location points P_{i,j} and P_{i,j+1}.

According to the method of the invention, an edge is defined between adjacent location points of a path history, i.e., between path history location points P_{i,j} and P_{i,j+1}. Furthermore, edges are defined between an intersection node and location nodes corresponding to location points of each of the respective two path histories between which location points the respective intersection point lies.

For example, when intersection point Xₖ is an intersection point of the m-th and n-th path histories between the location points P_{m,q} and P_{m,q+1} and P_{n,r} and P_{n,r+1}, then an edge is defined between the intersection node corresponding to intersection point Xₖ and each one of the location nodes corresponding to location points P_{m,q}, P_{m,q+1}, P_{n,r} and P_{n,r+1}, respectively, i.e., a total of four edges connect the intersection node corresponding to intersection point Xₖ with the location nodes corresponding to location points P_{m,q}, P_{m,q+1}, P_{n,r} and P_{n,r+1}.

The method according to the invention further comprises a step of generating, in a reduction step, a reduced graph by removing redundancies of the path histories. Redundancy of path histories mean that different entities are travelling or have travelled a same road segment (a same lane) and thus their respective path histories (or sections of their path histories) are the same or very similar to each other. It is preferred to remove such path histories as they are not adding any additional information to the local high-definition map, thus are to be filtered out.

Preferably, the reduction step comprises a merging step to merge redundant path histories, wherein two or more path histories are redundant if they correspond to a same road link, e.g., a same section (and preferably a same lane) of a road link.

The merging step preferably comprises
providing a predefined similarity threshold value,
defining a similarity value of a section of two of the path histories, and
merging location nodes of said two path histories in case their similarity value is within the predefined similarity threshold value.

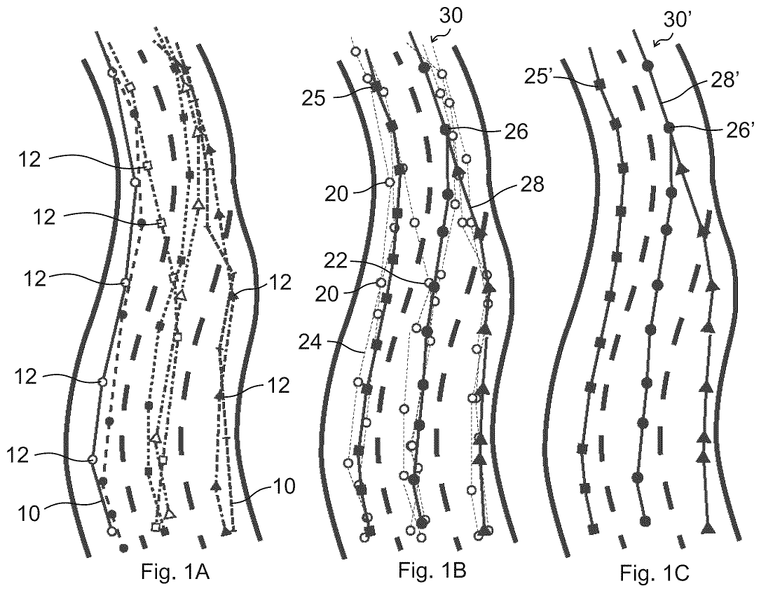

Preferably, the similarity value is determined based on a lateral distance of location points of the respective two path histories. If two or more path histories or sections of path histories can be marked as mergeable, they can be merged into one path by eliminating the nodes and edges of the redundant section and defining nodes and edges of the merged section, see for example FIG. 1B.

Preferably, the reduction step comprises an edge removing step to remove spurious edges, wherein spurious edges correspond to arbitrary lane changes, e.g., a lane change that was performed due to an overtaking manoeuvre. These lane changes typically appear at random locations, thus probably none of the other path histories include such a lane change. In a preferred implementation of the method according to the invention, an edge is removed if it is only connected to merged sections of the reduced graph. This approach ensures that road sections travelled by only a single entity are not discarded, but included in the local high-definition map.

Preferably, the reduction step is performed in iterations, i.e., the merging step and/or the edge removing step is performed in iterations until all the redundancy of the path histories and all the spurious edges are removed. The resulting reduced graph can be used as a local high-definition map. An advantage of the method according to the invention is that the resulting local high-definition map will also reflect temporary disruptions, e.g., unavailability of a lane due to an accident or a roadwork, etc. Therefore, the resulting local high-definition map is advantageous for V2V (vehicle-to-vehicle) collision-detection scenarios.

FIGS. 1A to 1C show an exemplary implementation of the method according to the invention in steps. FIG. 1A shows received path histories 10 of a given road segment having a merging lane. Each path history 10 comprises a set of location points 12, and for easier visibility, same symbols denote location points 12 belonging to the same path history 10. By connecting location points 12 belonging to the same path history 10, a path travelled by an entity can be even better visualized.

FIG. 1B shows location nodes 20 corresponding to the location points 12 and an intersection node 22 corresponding to an intersection of two path histories 10. The location nodes 20 and the intersection nodes 22 are nodes of the initial undirected graph. Edges 24 are defined between adjacent location nodes 20, i.e., location nodes 20 corresponding to location points 12 denoted by the same symbols in FIG. 1A. Furthermore, edges 24 are defined between the intersection node 22 and the closest location nodes 20 corresponding to the intersecting path histories 10.

Furthermore, FIG. 1B shows an example of a reduced graph 30, wherein location nodes and edges of redundant path histories are merged. The reduced graph 30 contains a merged location node 25, a merged intersection node 26 and merged edges 28.

FIG. 1C shows an example of a reduced graph 30′, that can be used as a local high-definition map, wherein the reduced graph 30′ has merged location nodes 25′, a merged intersection nodes 26′ and merged edges 28′. It can be seen from FIG. 1C, that in the case of merging lanes, the method according to the invention does not prune the connecting sections, however an arbitrary lane-change between the other two lanes has been eliminated in the process.

It is to be noted that the more path histories 10 are available in a certain geographical location, the higher the precision of the assembled local high-definition map. Therefore, it is advantageous if a sufficient number of V2X entities are available in that geographical location. The content of a V2X message in all major regions of the world may contain information about an entity's past/recent motion (also known as a path history), which information can serve as a basis of assembling a local HD map.

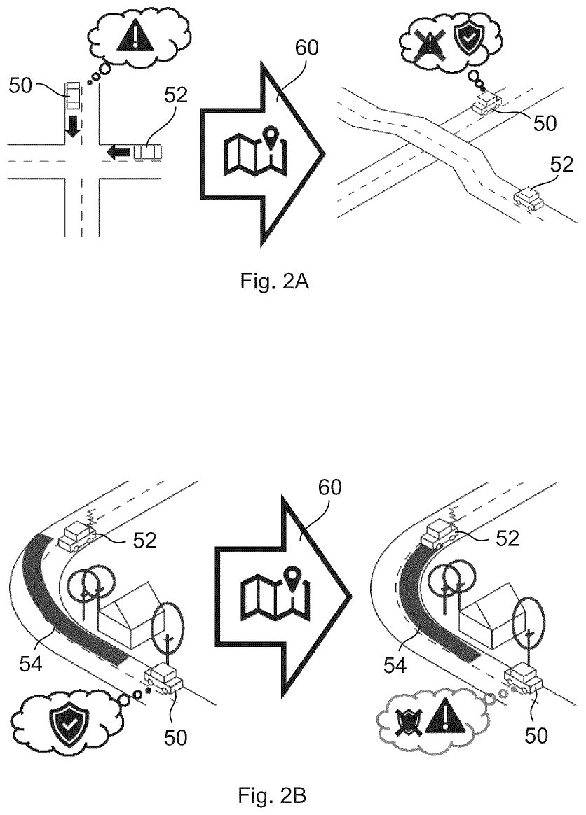

The method according to the invention helps to aid several V2X-based applications that require lane-level map-matching in order to avoid false situation assessment. As an example, a forward collision warning (FCW) application is usually designed to check a motion of an ego-vehicle 50 relative to another object(s) 52 in front, i.e., driving ahead in a same lane as the ego-vehicle 50. This scenario is depicted in FIG. 2B. If a region 54 ahead of an ego-vehicle 50 is not defined according to the actual driving and road conditions, e.g., a region 54 with a different curvature is predicted for the ego-vehicle 50 to move along, either false warnings or missed warnings can occur. Therefore, it is important to define the region 54 ahead of the ego-vehicle 50 according to the actual geometry of the road to be travelled, thereby the efficiency of forward collision warning can be significantly increased.

Another example is when a driver of an ego-vehicle 50 intends to perform a lane change and an application is designed to check whether another object 52 is dangerously approaching in a targeted adjacent lane. In such cases, accurately determining a relative lane position of two objects is of paramount importance.

Being aware of a local high-precision map is also beneficial for other collision detection methods and applications. Knowing which locations can be reached from a certain starting point can help to falsely detect potential dangers in situation, wherein the local road map does not allow physical transition from one location into an other one. If there is no available map information in a scenario according to FIG. 2A, an ego-vehicle 50 can receive a collision warning, but in reality, if the roads used by the ego-vehicle 50 and the another object 52 are not intersecting each other, it is impossible for a collision to happen.

In contrast to current, mainly radar-based solutions, which can only detect and signal collision hazards in a straight line and within a certain distance, the solution we describe is able to provide a highly accurate collision hazard signal (Forward Collision Warning) based on the location and movement information of each vehicle, while being able to suppress false signals by observing that the vehicles are unlikely to interact given their location, trajectory and road topology. However, this is only possible with HD maps that include lane data.

The present invention also relates to a system for providing map-related information for a traffic safety application. The system according to the invention is preferably implemented on a processing entity, or it can be distributed over several processing entities. A processing entity can be a vehicle, a part of a vehicle or a part of an infrastructure.

The system according to the invention is adapted for receiving digital map data 79, and a location of an object. Preferably, the system can further be adapted to receive movement dynamics data of the object. An object can be a vehicle or an other traffic participant such as a cyclist, a pedestrian or a motorcycle, etc. In general, an object can be any physical or virtual entity that can be associated with a geographical location. The object can be stationary or can be moving. The object can be equal to the processing entity itself, i.e., the processing entity on a vehicle. In this case we refer to the object as the ego-object, or ego-vehicle. In any other case we refer to the object as the remote object or the remote vehicle.

Preferably, the digital map data 79 received by the system can be provided by the method according to the invention or by a map provider 78. The system preferably can obtain the digital map data typically from any wired or wireless internet access but in general from any other source and way.

In V2X/C-ITS systems entities can communicate with each other via dedicated wireless communication channels (e.g., DSRC, C-V2X PC5). Location information 71 and/or movement dynamics data of a remote object such as a remote vehicle 72 can be obtained by receiving data on these channels, but in more general, this data can be obtained from any other source. Data of a remote object is typically first processed by a dedicated protocol stack and then stored in the object database 70.

An ego-object can typically obtain its own ego-position data 73 (geographical location), for example, by an ego-positioning sub-system 74 using well known global positioning systems (GNSS 75, RTKS 76) and/or using Dead Reckoning (DR) algorithms 77, but in general this information can come from any source.

The system according to the invention further comprises a map-matching module 80 adapted for calculating map-matched location information based on the location of the object and the digital map data. The map-matching module 80 preferably uses any known map-matching method or algorithm known in the art.

The system according to the invention further comprises an object database 70 connected to the map-matching module 80, wherein the object database 70 is adapted for storing the location of the object and a map-matched information of the object calculated by the map-matching module 80.

Preferably, the location of the object is provided by a remote vehicle 72 and/or by an ego-positioning sub-system 74 connected to the object database 70 and/or to the map-matching module 80.

The system according to the invention preferably further comprises an object prioritization module 82 adapted for determining objects for which a map-matching is to be performed by the map-matching module 80, wherein the object prioritization module 82 is in connection with the map-matching module 80. Details of the object polarization module 82 will be discussed later.

The system according to the invention preferably further comprises one or more map-aware filters 88 adapted to classify objects of which data is stored in the objects database 70 based on their relevance to an entity hosting the system. Preferably, classification of objects by map-aware filters 88 are performed based on a distance of the location of the object and the location of the entity hosting the system.

The object database 70 is preferably in a communication connection with a map-aware application 90, wherein the map-aware application 90 is a forward collision warning module, an intersection movement assist module, and/or a context-based prioritization module.

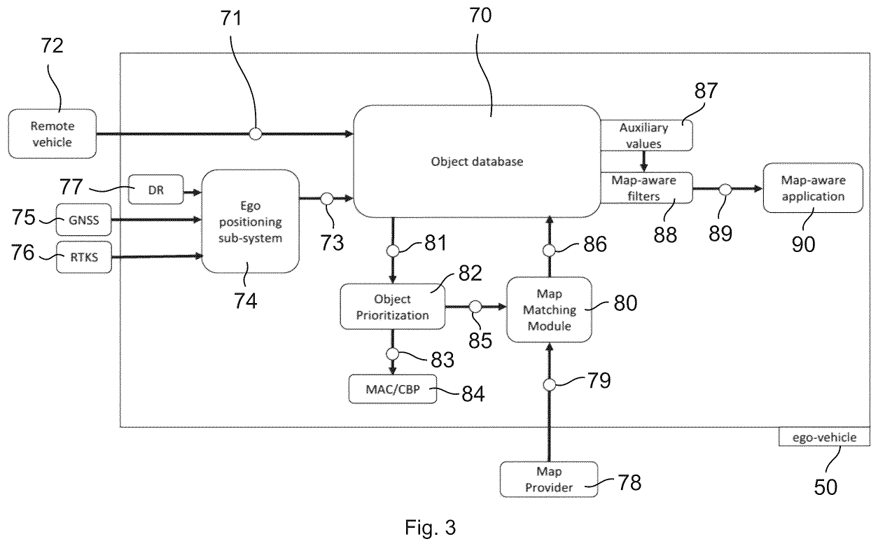

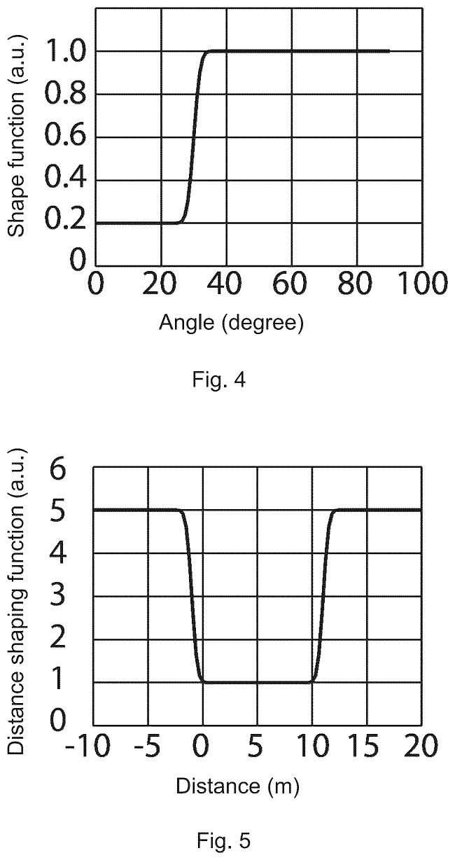

A preferred, exemplary implementation of the system according to the invention is shown in FIG. 3.

In FIG. 3, the system is implemented on an ego-vehicle 50 that is capable of receiving location information 71 and/or movement dynamics data of a remote vehicle 72. The ego-vehicle preferably further has an ego positioning sub-system 74 that is connected to positioning systems such as a GNSS 75 and a RTKS 76, and it is also capable of using Dead Reckoning (DR) algorithms 77 to determine an ego-position data 73. According to this specific example, the location information 71 of the remote vehicle 72 and the ego-position data 73 determined by the ego positioning sub-system 74 is fed to an object database 70.

The system according to FIG. 3 further has a map-matching module 80 that is connected to the object database 70 to store map-matched object data 86 calculated by the map-matching module 80. The map-matching module 80 preferably uses digital map data 79 received from a map provider 78, or a local HD map either received from a map provider 78 or an entity that calculates it based on recent local path histories (e.g., by using the method according to the invention). The ego-vehicle 50 can also be the entity calculating a local HD map. The local HD map in any cases is preferably calculated in real time.

In order to reduce the computations carried out by the map-matching module 80, the system includes an object prioritization module 82. Whenever new information is received about an object, the object database 70 consults with the object prioritization module 82 (e.g., by sending an object position 81 to the object prioritization module 82), whether there is a need to compute new map-matching metadata based on the new information. The object prioritization module 82 preferably returns a filtered set of objects 85 for which new map-matching information needs to be computed. Based on the filtered set of objects, the object database 70 preferably requests the map-matching module 80 to compute new map-matching information. The map-matching module 80 preferably uses current and past geographical locations of objects and digital map data 79 (preferably provided by a map provider 78) to compute map-matching information for the filtered set of objects. During this process the map-matching module 80 matches each object of the filtered set of objects to the best suitable map object and preferably provides at least the following information:
A road or a link (a map entity) the object (e.g., a vehicle) is on.
A location of the object on the matched map entity (e.g., on the road).
A direction of movement of the object along the matched map entity (e.g., along the road).

The map-matching module 80 preferably passes a newly computed map-matching information (a map-matched object data 86) back to the object database 70 where it is stored. The map-matching information is preferably provided for map-aware applications 90 using map-aware filters 88. The map-aware filters 88 can use some auxiliary values 87 that are common for most map-aware filters 88 and are updated every time a new map-matching information is available. The map-aware filters preferably transmit filtered object data 89 to the map-aware applications 90. Examples of how map-aware applications 90 can use this information is described later.

Parallel of the process described above, the object prioritization module 82 preferably sends a set of MAC addresses 83 of objects to a Context Based Prioritization module 84 (running in a MAC layer) that are not relevant sources of information and thus should be filtered at lower layers. Details of map-matching driven and Context Based Prioritization (CBP) are given later.

First, preferred implementation of the object prioritization module 82 is introduced in more detail.

Since matching a vehicle or other entity against a digital map data 79 is an expensive task, it is beneficial to include a component in the system whose task is to determine which vehicles or entities are “worth” matching in a specific processing cycle. The main idea behind this is that the system selects a few vehicles or entities that will be map-matched while a computationally much cheaper algorithm is applied to all the other entities, e.g., ones that are less relevant from an ego-vehicle 50 point of view. Additionally, prioritisation rules are preferably chosen so that safety is maintained, i.e., potentially dangerous situations are analysed using up-to-date information.

To accommodate object prioritisation, a map-matching module can be redesigned to use a post-trigger functionality of an entity subscription interface of the object database 70. This allows the system to collect all the updates within a process cycle, assign them priority values and determine how each object should be handled afterwards.

Preferably, a priority list is set up in the object prioritization module 82 which is based on various rules. A set of vehicles is considered to inherently have high priority and their priority in decreasing order is preferably as follows:
The ego-vehicle 50 which is required to be map-matched every time it is updated.
New objects, to gain information about their location and motion relative to the ego-vehicle.

Apart from the above objects, objects are categorised according to their location on the road network relative to the ego-vehicle 50. Those objects that drive on a same road as the ego-vehicle 50 or on a road that connect to that road of the ego-vehicle 50 are assigned higher priority than the rest. This categorisation is supported by filters that will be introduced later.

Preferably, higher priority objects are further categorised based on their distance on the road relative to the ego-vehicle 50. Those objects that drive closer preferably have higher priority values and within this category, there is a distinguished set of objects that involve those that are expected to interact with the ego-vehicle 50 in the nearest future.

To summarise, preferably, the following priority groups can be defined, ordered from the highest priority, wherein a priority value of each object is shown in parentheses:
Ego-vehicle (0)
Closest objects (1)
New/never map-matched objects (2)
High priority objects (last match timestamp).
Medium priority objects (last matching timestamp+medium priority match interval time).
Low priority vehicles (last matching timestamp+low priority match interval time)

The object prioritization module 82 preferably picks a first N objects in the list above to be map-matched by the map-matching module 80. To those objects that are not matched in a processing cycle, a prediction is applied, which has a negligible cost compared to map-matching. If according to the prediction, an object is likely to have passed an intersection, it will be assigned a high priority since such an object may suddenly change its priority class.

The object prioritization module 82 may take the following information into account
Inputs
   Object data
      Individual motion parameters (position, heading, speed)
      Object density (number of objects within the coverage area)
   Digital map data 79 (optional)
      Road topology and geometry.
      Location of the ego-vehicle 50 and remote objects.
Filtering concepts (The following filtering concepts can be combined to build up a custom complex rule set, without a need for completeness)
   Geometric distance based filtering
      A static size or an adaptive size (e.g., based on an ego speed or an object density)
      Regions of various shapes can be defined around the ego-vehicle 50
         A circular region
         A rectangular region, possibly with an offset relative to the ego-vehicle 50
   Road topology aided distance based filtering
      A distance between the objects is based on a road distance (a distance along a road)
      Otherwise, similar to the geometric counterpart
   Road-relative filtering
      Objects located on the same road as the ego-vehicle 50
      Objects located on roads connecting to the road the ego-vehicle 50 is driving on.
      Directional filtering (remote objects driving in the same or opposite direction relative to the ego-vehicle 50)
   Filtering based on object characteristics
      Objects driving at a particularly high speed
      Hard-braking objects
      Special vehicles
Minimum interval between accepted incoming messages (per source)
   Can be chosen as a fixed constant value within a specific area
   Can be set as a function of a parameter (e.g., a geometric/road-based distance from the ego-vehicle 50).
Filtering rule set examples (values not necessarily conformant with the aimed PPS values)
   Without digital map data 79
      Top priority objects (no filtering)
         Satisfying all the criteria below: Within a 10 m by 200 m rectangular area, centered at the ego-vehicle 50, pointing to the direction of motion of the ego-vehicle 50. Driving in the same (geometrical) direction as the ego-vehicle
      Medium priority objects (accepting messages every 1 s).
         Having a distance of less than 300 m from the ego-vehicle 50, not belonging to the previous group
      Low priority objects (accepting messages every 2 s)
         All other objects
   If digital map data 79 is available
      Top priority objects (no filtering).
         On the same road as the ego-vehicle 50, within the distance of less than 100 m, driving in the same direction on the road.
         Additional criteria on the remote object (if any of the items below matches): The closest relative to the ego-vehicle 50 ahead/behind Having a speed difference of at least 30 km/h (positive or negative) Having an acceleration less than −5 m/s∧2
      High priority objects (accepting messages every 500 ms)
         Objects on the same road as the ego-vehicle 50, within 100 m, driving in the same direction as the ego-vehicle 50, not belonging to the previous group
      Medium priority objects (accepting messages every 1 s).
         Objects on the same road as the ego-vehicle 50, within the range of 100 m to 300 m, driving in the same direction as the ego-vehicle 50
      Low priority objects (accepting messages every 2 s)
         All other objects

As it has been discussed above, the map-aware filters 88 can use additional data, e.g., auxiliary values 87 to support filtering and map-aware applications 90. It has been recognized that filtering and map-aware applications 90 can be more efficient if certain variables are already calculated at a lower level, to avoid calculating them several times when checking various pairs of vehicles/objects. Therefore, apart from determining an ID for a current link (i.e., a part of a road), i.e., a current link ID, that current link a vehicle is driving along, further pieces of information are calculated and collected instantaneously.

Preferably, basic values can include a position projected onto a centreline of the current link, an ID of a node the vehicle is heading towards along the link as well as the ID of a last one the vehicle has already passed by, a remaining distance to a next node and a length of the current link.

However, as it can often be noticed in a connectivity graph, roads tend to be split into multiple links for various possible reasons, even between road junctions. When checking for remote vehicles travelling on a specific road, such links should be collected and be treated as a whole. This will improve the filtering process and thus the application performance. As an illustrative example, when checking for forward collision risk, vehicles travelling on the same road ahead of the ego-vehicle 50 need to be selected first. If search is restricted to the link the ego-vehicle 50 is driving on, there will be a considerable amount of neglected but relevant vehicles (objects) driving ahead on another connecting link. This approach can be improved by considering the connecting links, aided by additional pieces of information, e.g., road classes, driver intentions (such as a turn signal, a speed, and a speed change).

Preferably, to extend a relevance area of a specific vehicle and to make searches more powerful, a search can be performed in the connectivity graph and the current link can be extended in both directions to find a road section between two junctions and a longest contiguous “straight” road section.

Just as in the case of the current link, the same pieces of information can be collected for these extended road sections. Furthermore, the direction of the last segment in each direction can be stored for the extended link, which is useful when an angle of connecting roads needs to be calculated.

As it has been briefly discussed above, map-aware filters 88 preferably perform classification and filtering.

Typically, especially when V2X and real-time information sharing between the actors in transport will be widespread, a local environment model is expected to comprise a vast number of non-stationary entities in a neighbourhood of an entity. Most of these entities usually have little or negligible influence on the motion of a host entity as they are not likely to interact within a reasonable time horizon. For computational performance reasons, a crucial step in situation analysis is, therefore, to efficiently select those entities that may be relevant from the host entity's point of view. The process of determining the relevance of remote entities involves several factors and cannot be simplified to, e.g., choosing a closest entity on a same road. Hereby, a set of tools that can be suitable for selecting relevant remote entities for further analysis are described.

Classification plays an important role in the framework of the object database 70. A set of binary decision variables is preferably calculated for remote entities that indicate simplified relationships between a remote entity and the ego-vehicle 50. When digital map data 79 is available, a subset of these variables can be calculated based on the result of map-matching, which is expected to lead to more accurate decision making.

The set of binary decision variables can indicate whether the remote vehicle 72 is ahead/behind the ego-vehicle 50, whether these are driving in a same or an opposite direction, whether these are approaching each other from left or right. If, additionally, lane-level information is available, one can even determine whether the two vehicles, i.e., the remote vehicle 72 and the ego-vehicle are driving in a same lane or how many lanes separate the remote vehicle 72 to the left or to the right relative to the ego-vehicle 50.

Therefore, the concept for the improved classification is that when map-matching results are available and up to date enough for both the ego-vehicle 50 and a remote vehicle 72, the appropriate relations can be determined using this information. Otherwise, an original classification is always available as a fallback option.

Apart from calculating basic relation information among pairs of vehicles, remote vehicles 72 can be filtered based on geometric properties. A filter in the object database 70 usually comprises a classification and a geometric requirement. The latter part can be used to restrict the selection of the vehicles of interest to those located in specific areas that can be described by their absolute location or relative to the vehicle of reference.

In certain cases, vehicles within a certain distance are considered relevant, while in others, those driving ahead or behind a reference vehicle. Among others, the object database 70 provides filters for selecting vehicles located within a polygon or a circle relative to the ego-vehicle 50, which are intended to filter vehicles driving on the same or connecting roads. Map information can be utilised to enhance these filters as well. Obviously, the filters described before can work well on straight roads, especially in such urban environments where vehicles travel at low speeds. However, this approach usually fails on roads or road connections where these assumptions do not hold (while it is possible to enhance the polygon during a curve, once the vehicle enters the curve, however the accuracy is found to be very poor without map-matching). Furthermore, relying on GNSS 75 altitude measurements (if altitude is available at all) may also lead to false results due to their poor accuracy.

Using map-matching, a different approach can be introduced. Checking for vehicles travelling on a same or a connecting road simplifies to comparing an identifier of a current road (a link) they are travelling on or comparing an identifier of an upcoming road connection (a node). The approach of checking the upcoming node IDs may be further extended to checking until a certain depth (in practice, 2) combined with link lengths.

Filters satisfying the needs of FCW, and IMA applications can be added to the object database 70. Preferably, two filters hare introduced, namely, a “Same Road Filter” and a “Connecting Road Filter”. As their names suggest, they are intended to provide a means of selecting vehicles that travel along a same or a connecting road segment as the vehicle of reference. The “Same Road Filter” preferably operates on an extended straight road information calculated in the map-matching result, while the “Connecting Road Filter” preferably checks a junction-to-junction road section. Apart from a usual classification flag set described above, both filters can feature a length property that can be configured to be static or adaptive (dependent on a speed of the reference vehicle) and can be used to filter remote vehicles within a distance.

The “Connecting Road Filter” can contain two further means to allow a user to filter remote vehicles according to his/her needs. Filtering can be restricted in a topological way by restricting the checks in the three base directions only, i.e., checking connecting roads from a left/right/front relative to a road the reference vehicle is travelling on. Additionally, a combination of left and right can also be added as an option, which comes handy in the case where a specific side is not relevant, just as is the case in an IMA application. Some filtering features can overlap with the classification features. The interface of the filter provides a larger configuration space and might prove to be more convenient to use.

Furthermore, the motion of each vehicle can be specified to be either approaching an intersection point or moving away from it. This feature comes handy in various situations. When one vehicle is required to move towards the intersection point while the other is moving away from it, it can be considered as extending a road, which will be crucial in FCW situations. Another frequent use case can be when only such vehicles are of interest that are moving towards the same intersection as the reference vehicle. An example to this use case is the IMA application in which a remote vehicle approaching from any side might turn out to be dangerous. Another use case could be a vehicle driving in the wrong direction in front of the reference vehicle.

The map-aware application 90 are preferably V2X applications that can greatly benefit from using a local HD map assembled by the method according to the invention.

As an example, two applications have been selected to compare situations in which the presence of map-matching is a decisive factor not only at a conceptual level, but a more established decision can also be made. A difference can be quantified in terms of false positive and negative cases in situations that an algorithm is inherently incapable of correctly evaluating without local road topology information.

The selected applications are forward collision warning (FCW) and intersection movement assist (IMA), see also FIG. 2A and FIG. 2B. Both applications first select remote potentially dangerous vehicles by applying classification and filtering. This step can be computationally cheap, especially in case, more than one application depends on a same filter. The situation is then preferably evaluated for each candidate vehicle and a notification is sent if a situation is flagged as dangerous. In the case of FCW, a time-to-collision (TTC) is a decision parameter, while the IMA preferably checks for a closest expected distance between two participating vehicles within a predefined time range.

In the absence of map information, one can see that both the selection of potentially dangerous vehicles and the situation assessment are performed purely on Newtonian principles, i.e., without any environmental constraints. This approach is obviously unable to consider a road curvature (at least before a vehicle sensor detect the curvature—and even at that point road geometry cannot be properly extracted) or elevation (GNSS 75 signals are typically have a poor quality in terms of elevation information) or non-connecting roads and thus lead to false evaluations, manifesting in both false negative and positive cases. These applications, therefore, needed to be enhanced with the original principles kept.

Map-Aware Forward Collision Warning (MA-FCW):

In the case of FCW, map-matching aided road/lane filtering can be applied first. This can select remote vehicles 72 driving in front of the ego-vehicle 50. As the location of the vehicles on a resulting link is available in the map-matching results, a distance between the two vehicles can also be calculated more precisely. The principles of an original (non-map-matching) FCW algorithm can then be applied, which (depending on the applied methods) results in a more accurate and reliable TTC value.

The map-matching based FCW can feature a “Same Road Filter” already discussed before that checks for vehicles on a same road section ahead of the ego-vehicle 50 in the same direction. This way it can be ensured that the ego-vehicle 50 does not lose track of potentially dangerous vehicles in areas where road intersections are located close to each other. The filter can be configured so that vehicles driving in front of the ego-vehicle 50 in the same direction are selected within a static or dynamic range. Once the filter triggers the application, the same analysis can be performed on the vehicle pair as in the case of the original FCW algorithm. However, in this case, distances along the road are considered instead of the distance of a spherical surface. Apart from the enable flags, the two applications can share the same configuration options. More detailed information on the configuration can be found in the documentation of an original FCW application.

The application can analyse a remote vehicle if it satisfies the following requirements:
It is travelling along the same road as the ego-vehicle 50.
It is located ahead of the ego-vehicle 50 on the road.
The ego-vehicle 50 and remote vehicle 72 are travelling in the same direction.
The distance between the remote vehicle 72 and the ego-vehicle 50 on the road is below a threshold value (which can be configured as a static or a speed-dependent dynamic value).

The application can be disabled below a configurable threshold speed value.

When the application is enabled, it shall calculate a time-to-collision (TTC) between two vehicles assuming the following:
There are no other vehicles between the ego-vehicle 50 and the remote vehicle 72.
The calculations may or may not consider the acceleration of the two vehicles.
If the acceleration is considered, it is assumed to be constant within the examined time.
Throughout the calculations, the length of the vehicles shall be taken into consideration.

When a calculated TTC value is less than a threshold value (which can be configured as a static or a speed-dependent dynamic value), the application shall trigger a warning.

Map-Aware Intersection Movement Assist (MA-IMA):

The IMA application can be enhanced in a fashion like that presented above. A candidate dangerous remote vehicle 72 drives on roads having connection with the ego-vehicle 50 within a certain distance. This criterion can be translated into map-matching terms as having an upcoming node in common within less distance left on the current link towards this specific node. This can be achieved by the aid of a “Connecting Road Filter” which is configured to trigger the application when remote vehicles are travelling on roads having a connection angle of about 90 degrees in any side relative to the road the ego-vehicle 50 is travelling on. Furthermore, the vehicles should drive in opposite directions and the remote vehicle 72 should be ahead of the ego-vehicle 50 according to the convention in the object database 70. Once such vehicles are found, it can be checked whether there is a risk of collision, i.e., they reach a connecting node around a same time or more precisely, whether they are expected to get within a threshold distance on their way. More precisely, it is checked for both vehicles how far the other vehicle is expected to be at the time they are supposed to reach a junction point, assuming each vehicle continues driving as they are at the time of checking. Preferably, the length of each vehicle is considered. If any of the calculated distances is lower than the threshold distance set in the application's configuration, a warning is triggered (with the estimated TTC value being the mean of the two time values the vehicles are expected to reach the intersection).

As in the case of the FCW application, the two IMA variants share a common configuration space. However, as can be seen in the description above, a present version of the map-matching variant does not consider the vehicle's acceleration and therefore, the corresponding configuration parameter has no effect. The rest of the configuration parameters can be found in detail in an original IMA documentation.

The IMA application preferably analyses a remote vehicle 72 if it satisfies the following requirements:
It is travelling towards the same intersection as the ego-vehicle 50.
It is approaching the junction/intersection from the left or right (vehicles approaching the intersection from the opposite direction should be ignored as in such cases, it is assumed that the vehicles are not on a collision course).
It is within a threshold distance from the intersection on the road (which can be configured as a static or a speed-dependent dynamic value).

The application shall be disabled below a configurable threshold speed value.

When the application is enabled, it shall calculate the TTC between two vehicles assuming the following:
The calculations may or may not consider the acceleration of the two vehicles.
If the acceleration is considered, it is assumed to be constant within the examined time period.
Throughout the calculations, the length of the vehicles shall be taken into consideration.

When the calculated TTC value is less than a threshold value (which can be configured as a static or a speed-dependent dynamic value), the application shall trigger a warning.

Map-matching driven, Context Based Prioritization (CBP):

Besides safety applications, map-matching based insights can also be used to create filtering rules for Context Based Prioritization. CBP is a method to filter out irrelevant messages at low layers of the networking stack, typically in a Medium Access Control (MAC) sublayer of a Data Link Layer. MAC sublayer filtering needs a set of MAC addresses to filter out. This set of MAC addresses is provided, and continuously updated by upper layers. Upper layers can create filters to get the set of MAC addresses that are not relevant for them and provide this set to the CBP functionality in the MAC sublayer. In the simplest implementation the MAC sublayer will not forward messages with MAC addresses found in the set. This offloads the whole computing entity as only relevant messages reach the upper layers. Traditional methods use filters that are based on a physical distance of the sending and receiving objects of the messages. In most cases this leads to poor results as distance-based methods cannot filter out transmitting stations that are in a proximity of the receiver (receiving object or entity) but still at an irrelevant location (e.g., an opposite direction traffic of a highway). On one hand in other cases traditional methods will filter out transmitting stations that are not in a proximity of the receiver but still are in relevant positions (e.g., a curved road).

With the help of the present invention map-matching insights can be used to create more accurate filters for CBP. From this perspective the MAC sublayer CBP functionality is just a special type of a V2X application.

The map-matching module 80 of the system according to the invention preferably uses an improved map-matching algorithm as described below.

Most of the known map-matching algorithms and research are focused on the problem of matching routes to sparsely sampled trajectories. The sampling range is usually between a few seconds up to several minutes. The reason for this is that most algorithms are applied in traffic monitoring, fleet management or surveillance systems which involve many vehicles that need to be tracked either online or the collected measurements need to be post-processed for various further use cases. Both involve processing of large amounts of data, which imposes high computational requirements.

Various approaches may lead to similar performance. A paper—Luo An et al.:, “Enhanced Map-Matching Algorithm with a Hidden Markov Model for Mobile Phone Positioning” ISPRS International Journal of Geo-Information 6, no. 11:327 (2017)—introduces a state transition model-based method. The state-transition models can build a weighted topological graph which contains all possible routes a vehicle might travel along. In this weighted topological graph, vertices represent the possible states the vehicle may be located at a particular moment, while the edges represent the transitions between states at different timestamps. Different from a road network, the weight of a graph element represents a possibility of a state or a transition, and a best matching result comes from an optimal path in the graph globally. There are three major ways of building the graph and solving the optimal path problem. Namely, Hidden Markov model (HMM), Conditional Random Field (CRF) and the Weighted Graph Technique (WGT).

HMM methods have a quite vast literature and fine results can be achieved by them. However, in the case of V2X, only online variants should be considered. These methods usually utilize future path prediction to tackle the problem of the need of future data and thus eliminate or reduce the latency naturally present in this method.

The idea behind a construction of a state transition matrix is simple. The weight of each transition depends only on the topological distance between links. The transition probabilities decrease as the topological distance increases. The authors of the paper suggest considering neighbours till the depth of 2, having weights 0.6, 0.4 and 0.2, respectively (0.6 corresponds to transitioning to the same link). The reasoning is obviously that it is less and less likely that a vehicle advances to a further link between consecutive measurements.

Similarly, the emission probabilities are chosen in a simple manner. The weights are inversely proportional to the distance between a link and a measured position.

Surprisingly, even these rules (that do not even consider the distance between the end of the link and the possible matching position corresponding to a measurement) result in a decent performance. However, slight modifications can be made to increase the accuracy of the algorithm in areas where the road network is more complex. These will be detailed below:

We have found two major weaknesses of the original algorithm that proved to result in poor performance in areas where road topology was considerably more complex than elsewhere. The original algorithm does not consider directional information in any sense. The other weakness of the original method is that it tends to match the same segment for a certain distance even when the vehicle has passed its endpoint. This is partly due to favouring the same link via higher weight values and due to the definition of the distance between a point and a line section. The method used by the map-matching module 80 of the system according to the invention preferably aim at attenuating the non-desired effects of these phenomena.

A similar approach is applied to both cases. If a combined “distance” is calculated that incorporates both a geometrical distance and an angular difference between road segments and vehicle motion directions in a multiplicative form. This combined distance is penalised when the angular difference is large (i.e., above a threshold) and has little effect when it is below a threshold. Likewise, the geometrical distance between a line section and a point is penalised (i.e., a larger distance is attributed to it) if the closest point of the line section to the given point is one of the line section's end points.

Sigmoid functions are suitable for this purpose. Sigmoid functions are monotonic functions with an inflection point, and they map the real numbers to a limited range. The error function, the logistic function and the tanh functions are some of the commonly used sigmoid functions.

In the case of an angular difference, a weighting function is designed that barely distorts a distance metric when the angular difference is low, while it adds a considerable amount above a threshold value, e.g., 30 degrees. The angle difference weight values can be chosen to be between 1.0 and a predefined maximum value, e.g., 5.0, or alternatively the angle difference weight values can be chosen to be between 0.2 and a predefined maximum value of 1.0, as shown in FIG.

4, depicting an exemplary weighting function (angle difference shaping) with an inflection point at 30 degrees.

A similar approach can be used for a geometrical distance. As can be seen in FIG. 5 showing an exemplary distance shaping function for a road segment having a length of 10 m, the main difference is that the weighting function is two-sided as the same kind of weighting needs to be applied on both ends of the road segments. The function has a shaping role since this weight is then multiplied by a distance between a given point and the road segment. The reason why the approach is slightly different from the one applied on the angular difference is to favour closer links instead of finding distant ones having better directional matches.

Therefore, the emission probability matrix elements can be calculated as an inverse of the following expression:

$$d = {f}_{shaping , dist} ( {x}_{proj} , {l}_{segment} ) \times {d}_{p , segment} \times {f}_{weighting , angle} ( {ϕ}_{veh} , {ϕ}_{segment} )$$

where
xₚᵣₒⱼ and I_{segment} are the coordinate of a projected point on the road segment and a length of the road segment, respectively,
d_{p,segment} is a distance between a point and the road segment,
Φᵥₑₕ and Φ_{segment} are a direction of motion of the vehicle and a direction of the road segment, respectively.

For numerical reasons, an offset is added to d_{p,segment} to avoid division-by-zero when calculating the emission probability matrix elements.

A V2X-specific improvement of a map-matching process can be a selection of the coordinates selected for map-matching. Both the ego-vehicle 50 and also the remote vehicles 72 send coordinates at a relatively high rate and the map-matching will only need to select a few based on the algorithm's needs, however this will still leave some flexibility in which position update to pick. The improvement is to realize a confidence-aware selection, which takes into account a position confidence of the coordinate and chooses a location (a data point) with a lowest confidence (highest precision). Confidence may vary based on coverage of a GNSS 75, number of synced satellites, dynamical movement of the vehicle and some other aspects as well, however they all impact the final confidence value added to the position update data structure and the highest quality point shall be chosen. Among the chosen points weighting can also be applied based on each finally chosen position points confidence, thus a more precise location point chosen for map-matching could have higher weight compared to a less precise (coordinate with higher confidence ellipse) coordinate also chosen for the given round of map-matching.

In summary, in making their decisions, driver assistance systems rely primarily on a distance of each vehicle. In a very significant number of cases, this leads to a large number of inaccuracies, as no consideration is given to whether or not each vehicle can interact with the other at all. These errors are due, on the one hand, to the fact that the driver assistance system may present certain situations as being significantly more dangerous than they actually are and, on the other hand, to the fact that there are more and more vehicles on the road equipped with increasingly sophisticated driver assistance systems, which are therefore more intensively communicating, and that it can therefore be expected that important information may be lost in the noise of the information.

Solutions to these challenges can be provided by map-matching solutions, which can help in the application domain to identify other vehicles relevant to the ego-vehicle 50. A prerequisite for this is, of course, the availability of high-resolution and reliable maps with sufficient detail for map-matching, in particular for nodes. An important part of the invention is that, if such a map is not yet available for a given area, it can be produced in real time under the right conditions, paving the way for more advanced and safer driver assistance systems with map-matching solutions.

The invention, furthermore, relates to a computer program product comprising instructions which, when the program is executed by a computer, cause the computer to carry out an embodiment of the method according to the invention.

The computer program product may be executable by one or more computers.

The invention also relates to a computer readable medium comprising instructions which, when executed by a computer, cause the computer to carry out an embodiment of the method according to the invention.

The computer readable medium may be a single one or comprise more separate pieces.

The invention is, of course, not limited to the preferred embodiments described in detail above, but further variants, modifications and developments are possible within the scope of protection determined by the claims. Furthermore, all embodiments that can be defined by any arbitrary dependent claim combination belong to the invention.

### List of Reference Signs

10 path history

12 location point

20 location node

22 intersection node

24 edge

25,25′ merged location node

26,26′ merged intersection node

28,28′ merged edge

30,30′ reduced graph

50 ego-vehicle

52 another object

54 region

70 object database

71 location information

72 remote vehicle

73 ego-position data

74 ego-positioning sub-system

75 GNSS

76 RTKS

77 DR algorithm

78 map provider

79 digital map data

80 map-matching module

81 object position

82 object prioritization module

83 set of MAC addresses

84 Context Based Prioritization module

85 filtered set of objects

86 map-matched object data

87 auxiliary value

88 map-aware filter

89 filtered object data

90 map-aware application

1. A method for assembling a local high-definition map, the method comprising the steps of
receiving a plurality of path histories, wherein each path history comprises a set of location points that an entity consecutively traversed,
constructing, based on the plurality of path histories, an initial undirected graph comprising location nodes, intersection nodes and edges, wherein
each location node corresponds to one of the location points,
each intersection node corresponds to an intersection point of two of the path histories, and
edges are defined between location nodes corresponding to adjacent location points of one of the path histories, and, in case of an intersection node, edges are defined between the intersection node and location nodes corresponding to location points of each of the respective two path histories between which location points the respective intersection point lies, and
generating, in a reduction step, a reduced graph by removing redundancies of the received path histories.

2. The method according to claim 1, wherein the reduction step comprises a merging step to merge a section of redundant path histories.

3. The method according to claim 2, wherein the merging step comprises
providing a predefined similarity threshold value,
defining a similarity value of a section of two of the path histories, and
merging location nodes of said two path histories in case their similarity value is within the predefined similarity threshold value.

4. The method according to claim 3, wherein the similarity value is determined based on a lateral distance of location points of the respective two path histories.

5. The method according to claim 1, wherein the reduction step comprises an edge removing step to remove spurious edges corresponding to arbitrary lane changes.

6. The method according to claim 1, wherein the reduction step is performed in iterations.

7. The method according to claim 1, wherein the path histories are received via vehicle-to-everything (V2X) messages.

8. A system for providing map-related information for a traffic safety application, the system adapted for receiving
digital map data, and
a location of an object,
the system comprising
a map-matching module adapted for calculating map-matched location information based on the location of the object and the digital map data, and
an object database connected to the map-matching module, wherein the object database is adapted for storing the location of the object and a map-matched information of the object calculated by the map-matching module.

9. The system according to claim 8, characterized in that the digital map data is provided by the method according to claim 1.

10. The system according to claim 8, characterized in that the location of the object is provided by a remote vehicle and/or by an ego-positioning sub-system connected to the object database and/or to the map-matching module.

11. The system according to claim 8, characterized by further comprising an object prioritization module adapted for determining objects for which a map-matching is to be performed by the map-matching module, wherein the object prioritization module is in connection with the map-matching module.

12. The system according to claim 8, characterized by further comprising map-aware filters adapted to classify objects of which data is stored in the objects database based on their relevance to an entity hosting the system.

13. The system according to claim 12, characterized in that classification of objects by map-aware filters are performed based on a distance of the location of the object and the location of the entity hosting the system.

14. The system according to claim 8, characterized in that the object database is in a communication connection with a map-aware application, wherein the map-aware application is a forward collision warning module, an intersection movement assist module, and/or a context-based prioritization module.

15. A non-transitory computer program product comprising instructions which, when the program is executed by a computer, cause the computer to carry out the method of claim 1.

16. A non-transitory computer readable medium comprising instructions which, when executed by a computer, cause the computer to carry out the method of claim 1.
